(19) United States
(12) Patent Application Publication
(10) Pub. No.: US 2022/0203965 A1
(43) Pub. Date: Jun. 30, 2022

(54) PARKING SPOT HEIGHT DETECTION REINFORCED BY SCENE CLASSIFICATION

(71) Applicant: Continental Automotive Systems, Inc., Auburn Hills, MI (US)

(72) Inventors: Julien IP, Royal Oak, MI (US); Eduardo Jose Ramirez Llanos, Auburn Hills, MI (US); Xin Yu, Rochester Hills, MI (US); Kyle Carpenter, Clarkston, MI (US)

(21) Appl. No.: 17/134,794

(22) Filed: Dec. 28, 2020

(51) Int. Cl. B60W 30/06; B60W 30/095; B60W 60/00; G08G 1/14; G05B 13/02; G06K 9/00

(52) U.S. Cl. CPC B60W 30/06; B60W 30/0956; B60W 60/0015; G08G 1/141; G05B 13/027; B60W 2300/14; G06K 9/00812; B60W 2420/42; B60W 2552/00; B60W 2554/20; G06K 9/00805

(57) ABSTRACT

An automated parking system for a vehicle according to an exemplary embodiment of this disclosure includes, among other possible things, a camera configured to obtain images of objects proximate the vehicle, and a controller configured to review the obtained images of objects proximate the vehicle to classify a location of the vehicle, determine a height of overhead objects associated with the classified location and initiate an automated parking function of the vehicle that corresponds to the determined height of the overhead objects.

### TECHNICAL FIELD

The present disclosure relates to driver assist and autonomous vehicle systems, and more specifically to a system and method of identifying an environment of operation based on images of an identified infrastructure near the vehicle.

### BACKGROUND

Vehicles may be equipped with a driver assist and/or autonomous vehicle operation system to operate a vehicle partially and/or fully independent of a vehicle operator. Information about the environment in which the vehicle is operating is needed to enable such systems to operate the vehicle. GPS and other positioning systems provide some information but may not always be available. Operation of the vehicle may vary depending on the environment and location. For example, a height of a ceiling in a covered parking area or other overhead obstructions should be known prior to executing a desired vehicle maneuver to enter the parking area.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An automated parking system for a vehicle according to an exemplary embodiment of this disclosure includes, among other possible things, a camera configured to obtain images of objects proximate the vehicle, and a controller configured to review the obtained images of objects proximate the vehicle to classify a location of the vehicle, determine a height of overhead objects associated with the classified location and initiate an automated parking function of the vehicle that corresponds to the determined height of the overhead objects.

In another example embodiment of the foregoing automated parking system, the controller includes a neural network to classify the location of the vehicle based on the obtained images of objects proximate the vehicle.

In another example embodiment of any of the foregoing automated parking systems, the camera obtains images of structures proximate the vehicle and the controller detects a height of overhead objects based on the type of structure detected in the images of structures.

In another example embodiment of any of the foregoing automated parking systems, the image of structures utilized for determining the height of the overhead objects includes at least one of a sign and/or text.

In another example embodiment of any of the foregoing automated parking systems, the image of structures utilized for classifying the location of the vehicle includes an image of a covered parking area and the overhead object is a ceiling portion of the covered parking area.

In another example embodiment of any of the foregoing automated parking systems, the controller initiates the automated parking function based in part on a configuration of the vehicle.

In another example embodiment of any of the foregoing automated parking systems, the configuration of the vehicle includes a trailer.

In another example embodiment of any of the foregoing automated parking systems, the controller initiates a scanning process for a desired parking spot based on a type of parking area. The controller operates to determine the type of parking area based on the images of structures.

In another example embodiment of any of the foregoing automated parking systems, the automated parking function includes defining a vacant spot for the vehicle to include two adjacent and vertically aligned vacant parking spots.

A controller for an automated parking system according to an exemplary embodiment of this disclosure includes, among other possible things, a processor configured to receive images from a camera mounted within a vehicle, review the obtained images of objects proximate the vehicle to classify a location of the vehicle, determine a height of overhead objects associated with the classified location and initiate an automated parking function of the vehicle corresponding to the determined height of the overhead objects.

In another example embodiment of the foregoing controller, the controller includes a neural network to classify the location of the vehicle based on a comparison of stored images corresponding to a known parking area and the obtained images.

In another example embodiment of any of the foregoing controllers, the neural network is configured to classify the height of overhead objects based on the type of structure proximate to the parking area.

In another example embodiment of any of the foregoing controllers, the processor initiates the automated parking function based on a configuration of the vehicle.

In another example embodiment of any of the foregoing controllers, the automated parking function includes defining a vacant spot for the vehicle is defined as two adjacent and vertically aligned vacant parking spots.

A method of automated parking spot detection according to an exemplary embodiment of this disclosure includes, among other possible things, obtaining images of a parking area proximate a vehicle with a camera mounted on the vehicle, determining a height of overhead objects based on the obtained images with a neural network and operating systems of the vehicle according to a predefined set of vehicle operating parameters that correspond to the determined height of the overhead objects.

In another example embodiment of the foregoing method, the neural network classifies a location of the vehicle based on infrastructure within the images obtained proximate the vehicle.

In another example embodiment of any of the foregoing methods, the method includes determining a configuration of the vehicle and operating systems of the vehicle based on the determined configuration of the vehicle.

In another example embodiment of any of the foregoing methods, the method includes determining the height of the overhead objects based on text within images of the infrastructure that is indicative of a height of the overhead objects.

In another example embodiment of any of the foregoing methods, the method includes determining the height of the overhead objects from an image of an entrance to the parking area.

In another example embodiment of any of the foregoing methods, the parking area is a covered parking area that includes a ceiling.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of a vehicle including an example an automated parking system embodiment.

FIG. 2 is a schematic view of an example controller for an automated parking system embodiment.

FIG. 3 is a schematic view of an example covered parking area.

FIG. 4 is a schematic view of an example outside parking area.

FIG. 5 is a flow diagram illustrating example steps for recognizing a height of overhead objects in a parking area.

### DETAILED DESCRIPTION

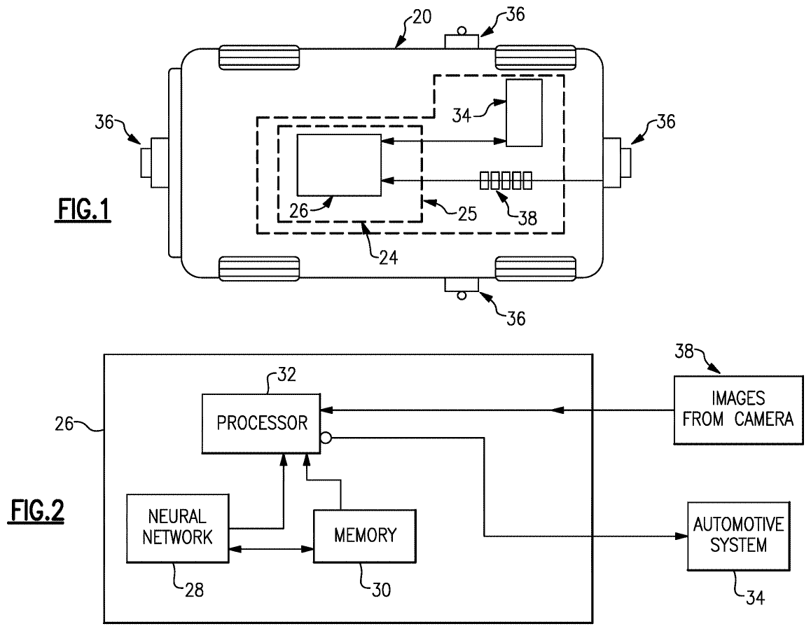

Referring to FIG. 1, a vehicle 20 is shown schematically and includes an automated parking assist system 24. The automated parking assist system 24 may be part of an overall driver assist or autonomous vehicle operating system indicated at 25. The automated parking assist system 24 includes a controller 26 that receives information in form of images 38 from at least one of several vehicle cameras 36 located around the vehicle 20. The controller 26 uses the images 38 from the cameras 36 to identify infrastructure around the vehicle 20 utilized to determine a height of overhead objects. The controller 26 either autonomously operates a vehicle system schematically shown at 34 and/or prompts a driver based on the identified infrastructure. The vehicle system is the steering and propulsion system to control a direction and speed of the vehicle 20.

In an example disclosed embodiment, the vehicle 20 uses the identified structure to determine and/or confirm a height of any overhead objects over a covered parking area and thereby operates the vehicle in conformance with the height of objects over the covered parking area. The controller 26 determines if the vehicle will fit within the covered parking area prior to entering and either prompts operation by a vehicle user or operates the vehicle based on the determination of height.

The disclosed vehicle 20 and operating system 25 are shown schematically and may be part of an operator assist system or a fully autonomous vehicle operating system. The example vehicle may be of any size, configuration and type.

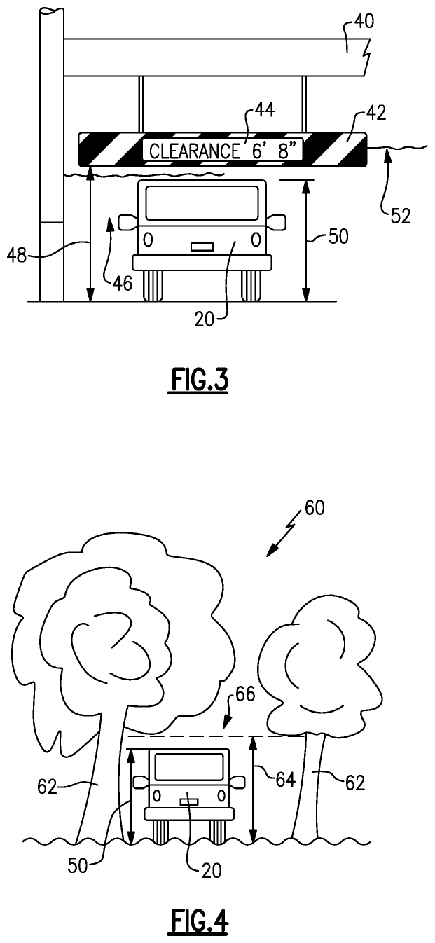

Referring to FIG. 2, with continued reference to FIG. 1, the controller 26 is schematically shown and includes a processor 32, a memory device 30 and an artificial intelligence algorithm such as a neural network schematically indicated at 28. Although the neural network 28 is shown schematically as an independent feature, it may be formed as portions of the processor 32 and memory 30.

The controller 26 and the processor 32 may be a hardware device for executing software, particularly software stored in the memory 30. The processor 32 can be a custom made or commercially available processor, a central processing unit (CPU), an auxiliary processor among several processors associated with the computing device, a semiconductor based microprocessor (in the form of a microchip or chip set) or generally any device for executing software instructions.

The memory 30 can include any one or combination of volatile memory elements (e.g., random access memory (RAM, such as DRAM, SRAM, SDRAM, VRAM, etc.)) and/or nonvolatile memory elements. Moreover, the memory 30 may incorporate electronic, magnetic, optical, and/or other types of storage media. Note that the memory can also have a distributed architecture, where various components are situated remotely from one another, but can be accessed by the processor.

The software in the memory 30 may include one or more separate programs, each of which includes an ordered listing of executable instructions for implementing disclosed logical functions and operation. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

Input/Output devices (not shown) that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the system 24 is in operation, the processor 32 can be configured to execute software stored within the memory 30, to communicate data to and from the memory 30, and to generally control operations of the system 24 pursuant to the software. Software in memory, in whole or in part, is read by the processor, perhaps buffered within the processor, and then executed.

The disclosed example neural network 28 operates as part of the controller 26 and processor 32 to identify images received by the cameras 36. The neural network 28 may be any combination of hardware and software that detects a height of a covered parking area such that the controller 26 may determine if the ceiling is high enough to accommodate the vehicle 20.

The example neural network 28 is taught to identify parking areas and particularly the height of overhead objects in a parking area by analyzing example images for features that are indicative of height that are so labeled. Such features may include text as part of a sign that identifies the height or other structures that provide a visual indication of the height of a covered parking area. Alternatively, the neural network 28 may be provided with images of structures with a known height at a known location.

The neural network 28 analyzes the provided images and using the results can identify with an acceptable level of certainty a height of overhead objects in similar images of covered parking areas. The neural network 28 continues to generate identifying characteristics corresponding with each infrastructure to further improve certainty levels and expand the number of different infrastructure identifiable by the system.

The disclosed example system 24 feeds a sequence of images to the neural network 28. The neural network 28 classifies the scene, recognizes the covered parking area or infrastructures and alerts the user or provides information on the overhead height. The neural network 28 continues monitoring and classifying the scene, including the opening and height to confirm and raise the confidence of the classification.

Depending on the type and configuration of the covered parking area, for example a campground or a parking structure, the system 24 may initiate a different behavior. Such detection and operating parameters are based on the location and vehicle configuration. For example, a taller vehicle with a roof rack may not be able to enter some parking structures when items are on the roof rack, while being able to enter when nothing is in the roof rack.

Referring to FIG. 3, with continued reference to FIGS. 1 and 2, an example parking structure 40 is shown with an adjacent sign 42. The sign 44 includes text 44 that indicates the height 48 of a ceiling 52 within the structure 40. The neural network 28 analyzes the images captured for indicators of the height 48. In this example, the text 44 provides that indication. In another example, a part of the structure 40 such as the sign itself 42 may provide the indication of the height 48. In such a case, the height 48 would be determined based on a comparison to a structure of a known size. For example, if the size of the sign 44 is known, a ratio between the size of the sign 44 and a size of the entrance may be determined and provide information indicative the entrance height 48. As appreciated, the features utilized to determines such a ratio may use a known alignment between the compared features.

Once the height 48 is know it is compared to the known vehicle height 50 and used by the controller 26 to confirm that the vehicle 20 may enter the structure 40. If the height 48 is not sufficient, a signal can warn the operator such that the vehicle operator does not pull into the parking structure. For autonomous operation, the controller 26 will bypass the parking structure 40 and look for other parking areas that will accept the vehicle. Once in the parking lot, other algorithms are implemented to detect an open space for parking.

The example automated parking system 24 may simply provide guidance to a user operator or provide complete autonomous operation of the vehicle to park the vehicle 20 without operator input. It is within the contemplation of this disclosure that any vehicle parking system will benefit from the identification and classification of parking lot configurations provided in this disclosure.

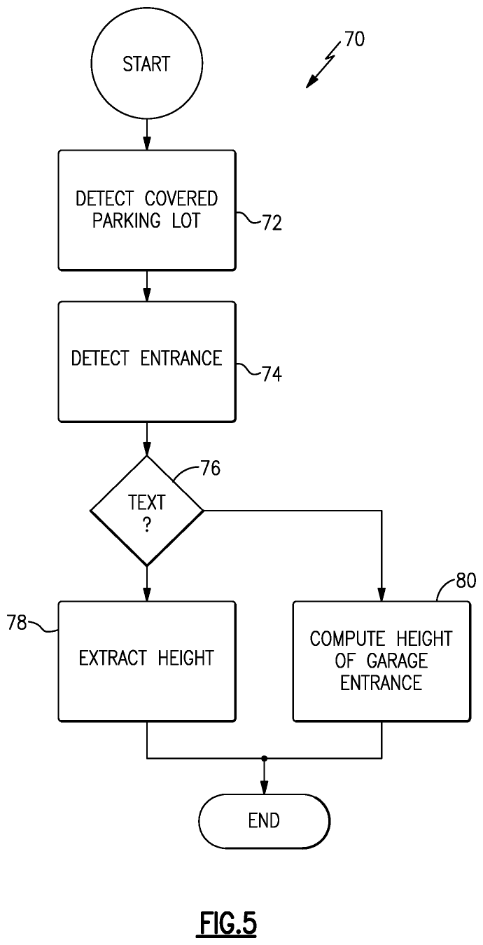

Referring to FIG. 4 with continued reference to FIGS. 1 and 2, a campground 60 is schematically shown and includes a parking area 66 at least partially covered by portions of trees 62. The disclosed system operates to ascertain a height 64 of overhead objects. In this example, the overhead objects are overhead branches that would prevent parking of the vehicle. The controller 26 uses artificial intelligence, such as the example the neural network 28, to predict or estimate the height and confirm that the vehicle may be safely parked in the parking area 66.

It should be appreciated that although a campground 60 and a parking structure 40 are disclosed by way of example, other covered and partially covered parking areas may be recognized and evaluate to assure a fit of the vehicle 20.

Referring to FIG. 5 with continued reference to FIGS. 1 and 2, a flow chart 70 is shown with example steps of operation for a disclosed automated parking system embodiment for detecting a height of overhead objects. The initial step is to detect a covered parking area or lot 72. The parking lot 72 is detected by analysis by the neural network 28 of surrounding structures and features such as the sign 42 shown in FIG. 3, or spaces 66 shown in FIG. 4. The system 24 detects an entrance 74 by the open space and other common features indicative of entry way. For example, the entrance 46 in FIG. 3 is defined under the sign 42 and between portions of the structure. The neural network 28 recognizes these features from previous images and based on the known vehicle environment. In FIG. 4, no entrance is defined, but the system 24 will identified the open parking area 66.

The system 24 searches through images 38 of the entry way for any text as indicated at step 76. If text is present, for example, the text 44 shown in FIG. 3, the height can be directly determined by reading that text as indicated at 78. If no text is present, then the images will be utilized to compute a height of the entrance as indicated at 80. The height of the entrance way can be computed using similar surrounding structure as a reference or by geometric methods using other vehicle sensors. Additionally, the height of a structure can be identified with a mono-camera. Moreover, other geometric methods including structure from motion (SFM) or simultaneous localization and mapping (SLAM) could be utilized and are within the contemplation of this disclosure.

Once the height is known, the controller 26 can confirm that the vehicle 20 is able to enter and operate within the covered parking area. The information and location of the parking area may be saved for future reference. Particularly, if the parking area is one that is often frequented by the vehicle 20.

Accordingly, the example system 24 provides for the determination of a height of a covered parking area with images obtained from the onboard cameras 36. Because images captured by the vehicle cameras are utilized, communication with external sensors or positioning systems is not required.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An automated parking system for a vehicle comprising:
a camera configured to obtain images of objects proximate the vehicle; and
a controller configured to review the obtained images of objects proximate the vehicle to classify a location of the vehicle, determine a height of overhead objects associated with the classified location and initiate an automated parking function of the vehicle corresponding to the determined height of the overhead objects.

2. The automated parking system as recited in claim 1, wherein the controller includes a neural network to classify the location of the vehicle based on the obtained images of objects proximate the vehicle.

3. The automated parking system as recited in claim 2, wherein the camera obtains images of structures proximate the vehicle and the controller detects a height of overhead objects based on the type of structure detected in the images of structures.

4. The automated parking system as recited in claim 3, wherein the image of structures utilized for determining the height of the overhead objects comprises at least one of a sign and/or text.

5. The automated parking system as recited in claim 3, wherein the image of structures utilized for classifying the location of the vehicle comprises an image of a covered parking area and the overhead object is a ceiling portion of the covered parking area.

6. The automated parking system as recited in claim 3, wherein the controller initiates the automated parking function based in part on a configuration of the vehicle.

7. The automated parking system as recited in claim 6, wherein the configuration of the vehicle includes a trailer.

8. The automated parking system as recited in claim 3, wherein the controller initiates a scanning process for a desired parking spot based on a type of parking area, wherein the controller operates to determine the type of parking area based on the images of structures.

9. The automated parking system as recited in claim 8, wherein the automated parking function includes defining a vacant spot for the vehicle to include two adjacent and vertically aligned vacant parking spots.

10. A controller for an automated parking system comprising:
a processor configured to receive images from a camera mounted within a vehicle, review the obtained images of objects proximate the vehicle to classify a location of the vehicle, determine a height of overhead objects associated with the classified location and initiate an automated parking function of the vehicle corresponding to the determined height of the overhead objects.

11. The controller as recited in claim 10, including a neural network to classify the location of the vehicle based on a comparison of stored images corresponding to a known parking area and the obtained images.

12. The controller as recited in claim 11, wherein the neural network is configured to classify the height of overhead objects based on the type of structure proximate to the parking area.

13. The controller as recited in claim 12, wherein the processor initiates the automated parking function based on a configuration of the vehicle.

14. The controller as recited in claim 13, wherein the automated parking function includes defining a vacant spot for the vehicle is defined as two adjacent and vertically aligned vacant parking spots.

15. A method of automated parking spot detection comprising:
obtaining images of a parking area proximate a vehicle with a camera mounted on the vehicle;
determining a height of overhead objects based on the obtained images with a neural network; and
operating systems of the vehicle according to a predefined set of vehicle operating parameters corresponding to the determined height of the overhead objects.

16. The method as recited in claim 15, wherein the neural network to classifies a location of the vehicle based on infrastructure within the images obtained proximate the vehicle.

17. The method as recited in claim 15, including determining a configuration of the vehicle and operating systems of the vehicle based on the determined configuration of the vehicle.

18. The method as recited in claim 16, including determining the height of the overhead objects based on text within images of the infrastructure that is indicative of a height of the overhead objects.

19. The method as recited in claim 16, including determining the height of the overhead objects from an image of an entrance to the parking area.

20. The method as recited in claim 19, wherein the parking area is a covered parking area that includes a ceiling.
